(19) United States
(12) Patent Application Publication
(10) Pub. No.: US 2012/0033775 A1
(43) Pub. Date: Feb. 9, 2012

(54) METHOD AND APPARATUS FOR INTERMEDIATE CONTROLLED FUSION PROCESSES

(75) Inventor: Ruggero Maria Santilli, Palm Harbor, FL (US)

(73) Assignee: HIGHFUELS, INC., Palm Harbor, FL (US)

(21) Appl. No.: 13/197,836

(22) Filed: Aug. 4, 2011

Related U.S. Application Data
(60) Provisional application No. 61/371,756, filed on Aug. 9, 2010.
(60) Provisional application No. 61/444,431, filed on Feb. 18, 2011.

(51) Int. Cl. G21B 1/00

(52) U.S. Cl. 376/107

(57) ABSTRACT

A method and apparatus for producing usable heat by fusion of two atoms within a vessel filled with a gas. The fusion is performed under pressure within an electric arc between two electrodes within the vessel. The electron clouds of the atoms are deformed into a toroidal shape by a magnetic field of the electric arc, thereby exposing the nuclei of both atoms. Upon such exposure, a trigger such as a sudden change in the arc or a sudden increase of pressure in the vessel forces the nuclei of the atoms to fuse, producing a new atom. Selection of the gas, the electrodes, as well as the operating power, pressure and flow through the arc results in the production of energy that is greater than the electric energy consumed by the arc. Heat produced by the fusion is used for the production of electricity or other commercial use.

### CROSS-REFERENCE TO RELATED APPLICATION

This application is a non-provisional application taking priority from U.S. provisional patent application Ser. No. 61/371,756, filed Aug. 9, 2010 and U.S. provisional patent application Ser. No. 61/444,431, filed Feb. 18, 2011, the disclosures of both provisional applications are hereby incorporated by reference.

### FIELD

This invention relates to the field of producing usable heat and more particularly to a system for producing usable heat without the emission of harmful radiation or the production of radioactive waste.

### BACKGROUND

Intermediate Controlled Nuclear Fusion without harmful radiations has been long sought for many reasons. One such reason is the production of energy. It is well known that both atomic fission and atomic fusion create significant amounts of energy that can be used to generate steam which is then routed to a turbine to produce electricity. Unfortunately, as evidenced by a recent natural disaster in Japan, the safety of using such energy is at question. Furthermore, in the process of generating energy, radioactive waste and contaminated materials are produced that remains radioactive for a very long time. To date, no totally effective, proper way of disposing of such waste and materials has been found.

Since the discovery of the composite character of atomic nuclei by Enrico Fermi and other scientists in the 1930s, major efforts have been conducted in various countries for the industrial development of energy sources of nuclear origin specifically intended for civilian uses, thus with the emphasis of preventing their explosive character. The prior art in the field of this invention is so vast to discourage partial and, therefore, discriminatory quotations, as illustrated by the vast number of patents released by the US Patent and Trademark Office in the civilian utilization of nuclear energies.

With due exceptions, prior endeavors in the field of nuclear energy can be classified into three distinct groups. Patents belonging to the first group deal with the fission of heavy nuclei as, for example, fission used in existing nuclear power plants. As it is well known, nuclear power plants emit neutron, alpha particles and other harmful radiations requiring expensive shielding of the reactor. As a by-product of the fission reaction, these power plants produce highly radioactive nuclear waste that, due to the lack of a process for recycling the radioactive nuclear waste into non-radioactive forms, are currently stored in special depositories resulting in known environmental problems. The solution to these known environmental problems is being left to be solved by future generations. All endeavors of this first group deal with the fission of heavy nuclei. As such, they do not anticipate a fusion processes that does not emit harmful radiation as will be explained and demonstrated. Furthermore, these endeavors deal with heavy, rather than light nuclei.

A second group of endeavors deals with attempts of achieving controlled nuclear fusions at very high energies, a process often referred to as hot fusions. As it is well known, despite the investment of public funds in various countries over the past fifty years estimated as being of the order of one trillion dollars, no controlled fusion has been achieved to date and none is in sight. In essence, there is no doubt that new nuclei are indeed synthesized at very high energies. However, the excessive amount of energy used to cause such instabilities is not controllable in a systematic way which would result in utility and industrial value. The endeavors of this second group all use high energies as a necessary pre-requisite to avoid uncontrollable instabilities, which prevention is necessary to have utility and industrial value.

The third group of endeavors deals with the fusion of generally light nuclei at low energy, often referred to as cold fusions. Efforts in the field can be traced back to claims in the 1920s by Friedrich Paneth and Kurt Peters on the apparent laboratory fusion of hydrogen into helium. This first claim was followed in subsequent decades by a number of isolated claims of nuclear fusions in a laboratory. In 1989, Martin Fleischmann and Stanley Pons claimed again the achievement of nuclear fusions by stimulating rather large research efforts in the field whose literature is nowadays also vast. Following large efforts, the actual synthesis of new nuclei at low energy is nowadays admitted by a majority of the scientific community, as attested by numerous publications on cold fusions in refereed journals of the American, European and other physical societies. However, despite large investments, cold fusion too has failed to achieve utility and industrial value to date. That is, cold fusion has failed to achieve an production of energy that exceeds the energy used to allow effective industrial production of energy.

U.S. Pat. Nos. 6,926,872, 6,673,322, 6,663,752, 6,540,966, and 6,183,604, all issued to Rugerro Maria Santilli, describe various approaches to producing a combustible gas using an electric arc, but do not fuse atoms together.

What is needed is a nuclear fusion system that will produce usable heat without the emission of harmful radiation or the production of radioactive waste.

### SUMMARY

In one embodiment, a method for intermediate fusion is disclosed. The fusion is forced between a first atom of a first element and a second atom of a second element without the emission of harmful radiation and without the release of radioactive waste. The first and second atoms are light, natural and stable. The fused atom resulting from the intermediate fusion is also being light, natural and stable. The method includes exposing the first and second atoms to a magnetic field within a pressurized chamber, causing the polarization of electron orbits into a toroid. Since the electrons of the first and second atoms now have a toroidal shape, the nuclei of the first atom is exposed to the nuclei of the second atom. A trigger then is used to force the nuclei of the first atom to fuse with the nuclei of the second atom, thereby fusing the first atom and the second atom into the fused atom.

In another embodiment, a method for intermediate fusion is disclosed. Intermediate fusion of a first element with a second element into a fused element is performed without the emission of harmful radiation and without the release of radioactive waste. Atoms of the first element and atoms of the second elements are light, natural and stable. Likewise, atoms of the fused element are also light, natural and stable. The method includes providing a pressure chamber having at least a positive electrode and a negative electrode within the pressure chamber. The positive and negative electrodes electrically connected to a switched source of power. Next, the pressure chamber is evacuated the filled with a gas, thereby increasing a pressure within the pressure chamber to an operational pressure (e.g., 300 to 3,000 PSI). The switched source of power is then enabled, thereby initiating an electric arc between the positive electrode and the negative electrode. Now, at least one trigger is provided (e.g. a sudden increase in pressure within the chamber, a pulse in the electric power, etc.) and atoms of the first element are fused with atoms of the second element into atoms of the fused element.

In another embodiment, an apparatus for intermediate fusion is disclosed. The fusion is made between a first element and a second element into a fused element without the emission of harmful radiation and without the release of radioactive waste. Atoms of the first element and atoms of the second element are light, natural and stable. Likewise, atoms of the fused element are also light, natural and stable. The apparatus includes a source of electric power and a pressure chamber. There are at least one positive electrode and at least one negative electrode within the pressure chamber and the positive and negative electrodes are electrically connected to the source of electric power. The apparatus includes a system for evacuating the pressure chamber and a system for filling the evacuated pressure chamber with a gas.

Filling of the pressure chamber with the gas increases the pressure within the pressure chamber to an operational pressure. The apparatus includes a way to initiate an electric arc between the at least one positive electrode and the at least one negative electrode and, once the electric arc is going, a way to trigger the fusion of atoms of the first element with atoms of the second element into atoms into atoms of the fused element.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates the random nature of atomic electron clouds in their natural spherical distribution and the formation of a toroid distribution under magnetic forces with exposed nuclei.

FIG. 2 illustrates the achievement by a DC electric arc of the toroid polarization of FIG. 1.

FIG. 3 illustrates the he axial triplet coupling of spinning nuclei.

FIG. 4 illustrates the new bond between polarized atoms of primary magnetic character.

FIG. 5 illustrates the planar singlet coupling of polarized nuclei that is not suitable under the polarization of FIG. 1.

FIG. 6 illustrates an exemplary apparatus used for its experimental verifications.

FIG. 7 illustrates the results of the chemical analyses showing a decrease of deuterium gas in the apparatus of FIG. 6 and the increase of nitrogen due the synthesis of deuterium gas and carbon.

FIGS. 8A and 8B illustrate the results of the chemical analyses confirming the synthesis of nitrogen in the apparatus of FIG. 6.

FIGS. 9A and 9B illustrate two configurations of flow of gas through an arc.

FIG. 10 illustrates an embodiment of an apparatus with a flow of the gas through the arc.

FIG. 11 illustrates another embodiment, also with the flowing of the gas through the electric arc.

FIG. 12 illustrates another embodiment allowing the replacement of the electrodes.

FIG. 13 illustrates another embodiment allowing an increased duration of the operations prior to the replacement of the electrodes

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures. Throughout this description, reference to a spherical form of the electron cloud of an atom refers to the natural, random travel of electrons around the nucleus of the atom. Reference to a toroid form of the electron cloud, or toroidal shape, refers to a polarized shape of the electron cloud in which the electrons travel in a generally donut-shaped cloud around the nucleus.

This invention deals with the realization of Intermediate Controlled Fusion processes, referred to as ICFP, and referring to an apparatus capable of producing usable heat in a fully controlled system via a number of mechanisms and processes occurring within nuclei, hereon generically referred to as fusion processes, that includes but is not limited to nuclear fusion. The heat being produced is without the emission of harmful radiations and without the release of radioactive waste.

The reasons for the failure by cold fusions to achieve utility and industrial value until now are numerous and can be summarized as follows: 1) Cold fusions attempts to date do not have means for the systematic and controlled exposure of nuclei out of their atomic electron clouds. As a result, fusions essentially occur at random, rather than in a controlled way. Nature has equipped atoms with a cloud of high energy electrons orbiting around nuclei. It is evident that, without the systematic control of said electron clouds in such a way to expose nuclei, no nuclear fusion is conceivable or otherwise possible because prevented by said atomic clouds. 2) Cold fusions attempts to date do not have systematic means to control the coupling of nuclei, particularly when the latter have non-null spin. It is known that the coupling of nuclei with parallel spin, called triplet coupling, causes large repulsive forces preventing any systematic fusion. Similar repulsive forces or uncontrollable instabilities occur when nuclei are coupled with random orientation of their spin, in which case fusions, at best, occur at random. 3) Cold fusions attempts to date do not have sufficient energy to implement all means necessary for systematic and controlled fusion, including the exposure of nuclei, the polarization of nuclear spins, the proper coupling of polarized nuclei, and other issues. Extensive mathematical, theoretical and experimental studies have been conducted for decades to resolve the insufficiencies of both cold and hot fusions. These studies are reported, for example, in the five volumes of “Hadronic Mathematics, Mechanics and Chemistry,” by Ruggero Maria Santilli.

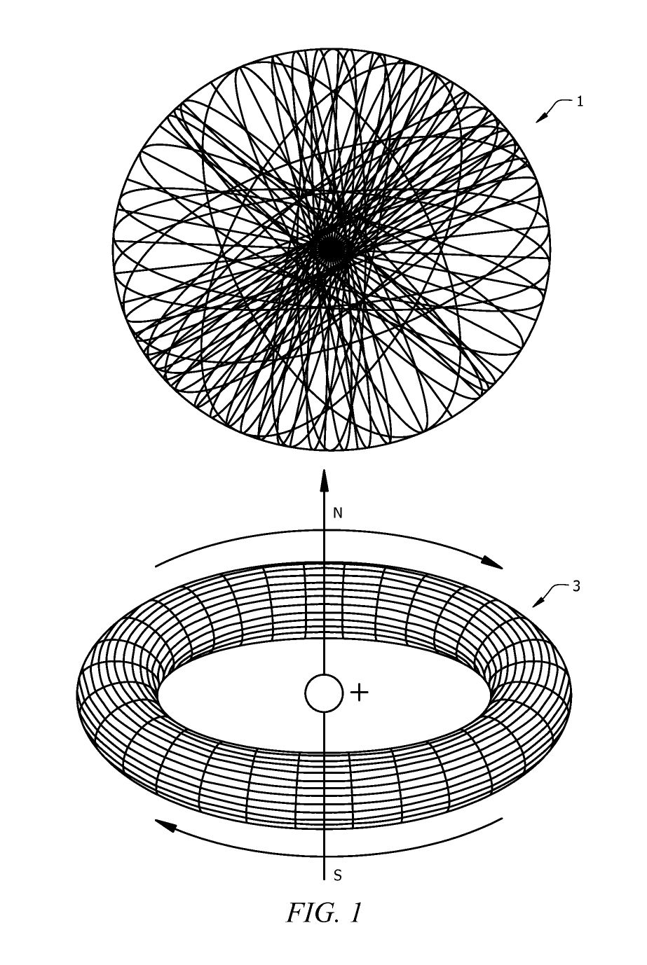

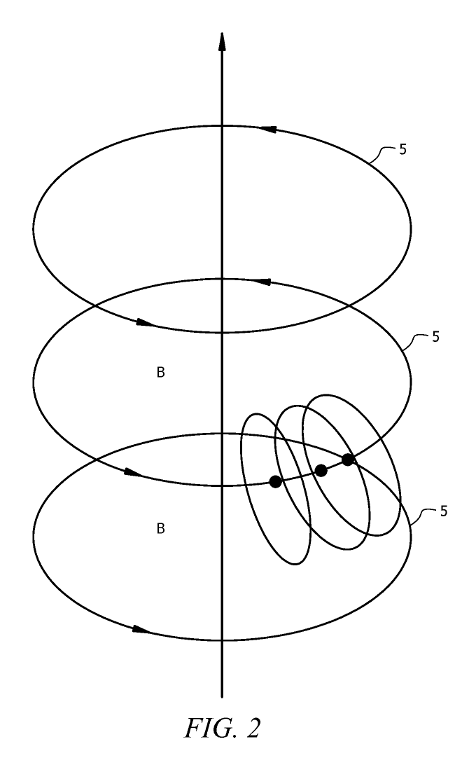

The “Hadronic Mathematics, Mechanics and Chemistry” studies have established the production of heat from nuclear processes in a systematic and controlled way resolving the shortcomings of the prior art in the field via the following main principles of ICFP: PRINCIPLE 1: Achievement of a systematic exposure of nuclei by controlling of atomic clouds from their spherical form 1 to a toroid form 3, hereinafter referred to as toroid polarization 3, as illustrated in FIG. 1. As will be shown, controlling of atomic clouds is performed in a pressure vessel filled with a suitably selected gas, in which the gas is traversed by a DC electric arc. As shown in Volume IV of “Hadronic Mathematics, Mechanics and Chemistry”, the control of atomic electron orbits is possible via magnetic fields. Control of atomic electron orbits requires very strong magnetic fields of the order of 10¹⁰ Gauss or more, namely fields thousands of time stronger than the strongest magnet currently available. Extensive studies and experimentation conducted for decades have established that magnetic field with such intensity are indeed effectively and systematically achieved at atomic distances from DC electric arcs, as illustrated in FIG. 2. In fact, magnetic fields generated by DC arcs generate a magnetic field with force lines constituted by circles with the direction of the arc 5 as their axial symmetry, and field intensity given by the law M=K A/r, where: A represents the DC current in Amperes; r represents the distance from the DC arc; and K is a constant depending on the assumed units whose explicit value is well known to skilled in the art. It then follows that for I=10³ A and R=10⁻⁸ cm, the magnetic field at atomic distances from the arc is of the order of 10¹¹ Gauss, thus being sufficient to cause the desired toroidal deformation 3 of the atomic clouds (see FIG. 1). The exposure of nuclei out of their atomic clouds is controllable in a systematic way by controlling the DC current to the electric arc, controlling of the pressure within the containment vessel and other means as will be described. The resulting production of energy is not explosive because the nuclear processes solely occurs at atomic distances from the DC arc, thus prohibiting/inhibiting a chain reactions as is needed for an explosive releases of energy.

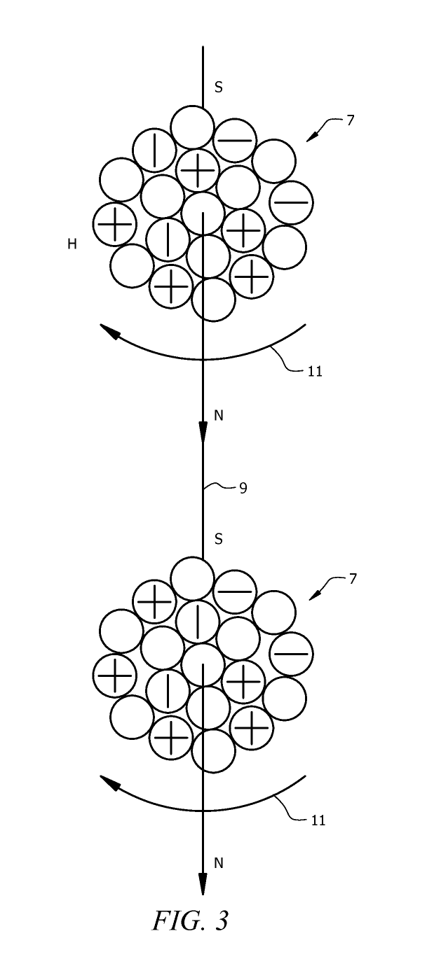

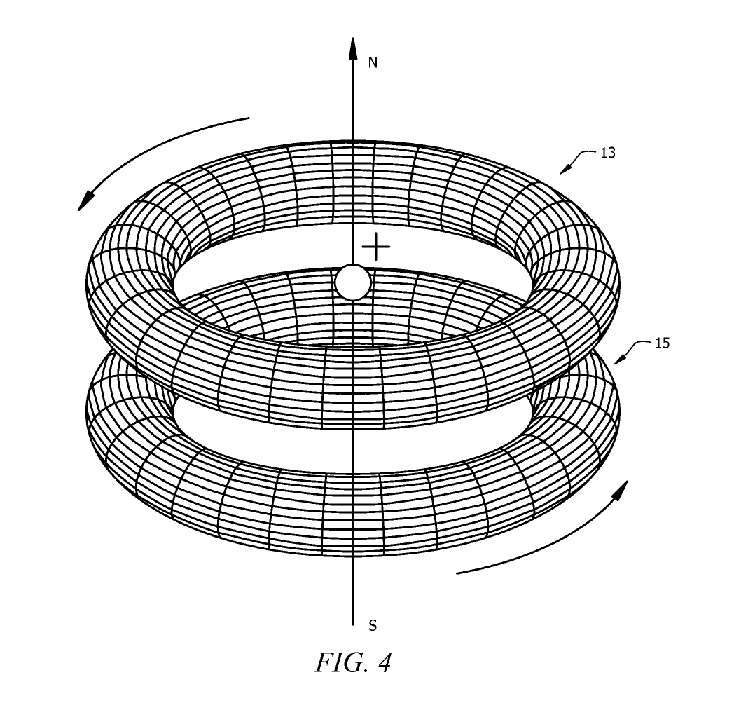

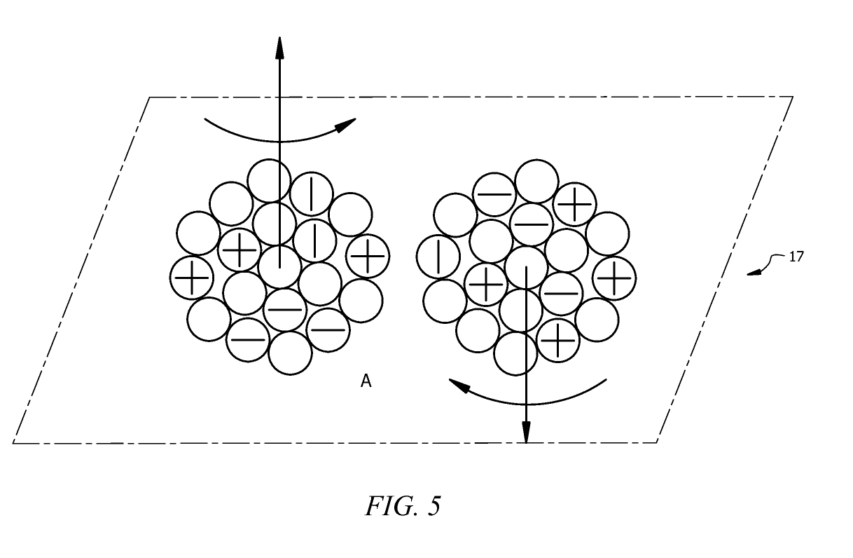

PRINCIPLE 2: Following the systematic exposure of nuclei as per Principle 1, systematic nuclear couplings in the preferred axial triplet configuration is performed as illustrated in FIG. 3. Namely, systematic coupling of nuclei 7 as having a common symmetry axis 9 and parallel spins 11 is achieved. Following extensive studies and experimentation reported in “Hadronic Mathematics, Mechanics and Chemistry”, it has been determined that a most effective way for the systematic implementation of the axial triplet coupling is given by the same DC electric arc achieving the toroidal polarization of FIG. 2. The DC electric arc causes a toroidal polarization of all atoms along a given force line, of which only two are represented in FIG. 3 for simplicity. Inspection of nuclei then confirms the axial triplet coupling of FIG. 3 as desired. This setting produces the configuration of a pair of toroid polarized atoms 13/15 according to FIG. 4, providing the needed premises for the desired fusion processes. The toroid polarization 3 of FIG. 1 is extremely unstable for an isolated atom because, due to collisions and other effects caused by temperature. The atomic orbitals return to acquire their spherical configuration nanoseconds following the termination of the DC arc. However, extensive studies, experimentation and chemical analyses as discussed in preceding U.S. patents to Ruggero Maria Santilli (referenced above) have established that the coupling of polarized orbitals 13/15 is stable at ambient temperature in that the configuration of FIG. 4 also acquires a spherical distribution nanoseconds following the termination of the DC arc, but the latter spherical distribution 1 refers to the coupled toroid polarizations and not to the individual polarizations. In fact, studies and experimentation reported in “Hadronic Mathematics, Mechanics and Chemistry” have established that the configuration of FIG. 4 is stable because the attractive forces in the coupled polarizations are stronger than the repulsive forces. More specifically, the configuration of FIG. 4 includes repulsive Coulomb forces between the positively charged nuclei as well as the negatively charged electron of the toroid polarizations 13/15. These repulsive forces are balanced by the attractive forces between the opposite nuclear magnetic polarities and the opposing electron magnetic polarities. In addition, there exist strongly attractive magnetic forces between opposing polarities of the magnetic field created by the orbiting of the electrons within the toroid polarizations 13/15, as such magnetic field do not exist in the natural state of atoms. Consequently, the ICFP Principle 2 herein considered is based on the creation of a new force field of magnetic character that does not exist in the natural state of atoms. The systematic use of the new force field for the preparation of the fusion processes is described below. In view of the above, generic toroidal configurations of the type of FIG. 4 will be referred to as magnecules, namely, as clusters of atoms whose bond is primarily of magnetic origin called magnecular bond. The term “magnecules” distinguishes such from conventional molecules, namely, cluster of atoms whose bond is solely of valence type (valence bonds). The former are denoted with the symbol “x”, while the latter are denoted with the symbol “−”. As an example, for the case of hydrogen, the configuration of FIG. 4 characterizes a hydrogen magnecule denoted MH_{—}2, while the conventional hydrogen molecule is denoted H_{—}2=H−H. For completeness, we indicate the existence of a second type of admissible coupling called planar triplet 17 as illustrated in FIG. 5. In this case, nuclei have a common plane symmetry axis and are coupled with antiparallel spins as it is the case for gears. Note that this coupling is not compatible with the toroid configuration of atomic orbitals of FIG. 3 since the same toroid polarizations prohibit nuclei to achieve contact, thus preventing fusion processes.

PRINCIPLE 3: Following the systematic exposure of nuclei as per Principle 1 and the systematic triplet axial coupling of nuclei as per Principle 2, an external action is applied. This action is hereafter referred to as the trigger and denoted as TR. The trigger forces nuclei at mutual distances equal or smaller than 1 Fermi=10⁻¹³ cm together under which conditions fusion the processes occurs due to the strongly attractive character of nuclear forces. Extensive studies and experimentations have established that, even though stable at ambient temperature to create the new chemical species of magnecules, the magnecular bond is insufficient for the two nuclei to achieve systematically the needed mutual distances of 1 Fermi or less due to inevitable fluctuations and other effects. Consequently, in order to achieve utility, consumer, and industrial value, it is necessary to engineer an external action that forces, in a systematic and controlled way, the two exposed nuclei 13/15 to obtain a mutual distance of 1 Fermi or less. A variety of triggers are anticipated. Preferred embodiments for this invention include triggers characterized by pulsating DC having around 100,000V electric arcs, sudden increases in pressure in the vessel of the apparatus, and other means.

PRINCIPLE 4: The fusion processes is usable for light natural and stable nuclei into light, natural, and stable nuclei as a necessary condition to assure lack of emission of harmful radiations and the lack of release of radioactive waste. In such, the impossibility of emitting harmful radiations is evident as will be discussed in more detail. The impossibility of releasing radioactivity waste is due, first of all, to the stability of the synthesized nuclei, and then to the gross insufficiency of the energy necessary to disintegrate nuclei as needed to release radioactive waste. In fact, the disintegration of nuclei in one of the embodiments of this invention would require energies millions of time greater than the energy actually provided, therefore assuring the lack of emission of harmful radiations and the lack of release of radioactive waste.

PRINCIPLE 5: Use the minimal possible energy, hereon referred to as threshold energy, for the realization of all principles, means and mechanisms, as well as the verification of energy and all other conservation laws. It is evident that the threshold energy is intermediate between the energy of cold fusions and that of hot fusions, for which reason this invention is referred as dealing with Intermediate Controlled Fusion Processes, ICFP. Intermediate Controlled Fusion Processes produces usable energy without the emission of harmful radiations and without the production of radioactive waste. To provide an order of magnitude, one industrial realization of the apparatus described requires 50 kWh and the arc occurs in the interior of a vessel filled up with the selected gas that is pressurized at 3,000 psi. In such, the DC electric arc as powered by 50 kWh traversing a gas that is pressurized to 3,000 psi pressure creates a plasma around the tips of the electrodes at about 5,000 degrees F. Such a high temperature illustrates why “Intermediate” is proper for: Intermediate Controlled Fusion Processes (ICFP). Note that in the presence of fusion processes, the temperature at the atomic distances of the DC arcs reaches millions of degrees F. as illustrated below.

To identify the main fusion processes that are possible under the above Principle 1 to 5, standard nuclear terminologies with symbols A, Z, JP, u, denote the atomic number, the nuclear charge, the nuclear angular momentum, the parity, and the energy in atomic mass unit u, respectively. All nuclei treated below, also referred to as nuclides, are fully identified and tabulated in the technical literature, such as the Table of Nuclides available from, for example, the Korea Atomic Energy Research Institute. Detailed technical review of the decades of studies preceding ICFP including the nuclear processes presented below by the physicists I. Gandzha from Kiev, Ukraine and J. Kadeisvili from Georgia, Russia under the title “New sciences for a New Era, Mathematical, Physical; and Chemical Discoveries of Ruggero Maria Santilli, expected to be published by the Sankata Printing Press in Nepal in mid 2011. The latter work will be referred to hereon as the Gandzha-Kadeisvili monograph.

A generic ICFP of this invention is then given by:

N₁(A₁,Z₁,J₁^{p1},u₁)+N₂(A₂,Z₂,J₂^{p2},u₂)+TR→→N₃(A₃,Z₃,J₃^{p3},u₃)+Heat, (1a)

A₁+A₂=A₃,Z₁+Z₂=Z₃,J₁+J₂=J₃,p1+p2=p3 (1b)

ΔE=E₃−(E₁+E₂)>0 (1c)

where TR denotes the trigger defined in Principle 3, and the produced energy is first acquired in the form of excitation of the synthesized nucleus and then released in the form of heat from the return of the synthesized nucleus to its natural ground state. The fusion processes (1) above follows all known conservation laws, including the conservation of the atomic numbers, conservation of the charge, conservation of the angular momentum under the triplet axial coupling, conservation of parity and conservation of the energy.

As a central feature of this invention, all initial and final nuclei must be light, natural and stable nuclei. The restriction of fusion processes (1) of the synthesis of light, natural and stable nuclei into a final light, natural, and stable nucleus then prevents any release of harmful radiation and the release of radioactive waste. It is anticipated that only a selected number of light, natural and stable nuclei are useful in ICFP (1), in which case they are often called in the technical literature hadronic fuels, as presented, e.g., in the Gandzha-Kadeisvili monograph. the name “hadronic fuel” originating from the covering of quantum mechanics known as hadronic mechanics, namely, a mechanics build for the structure of strongly interacting particles called hadrons. Consequently, the apparatus of this invention is called a hadronic reactor.

As identified below, hydrogen is not recommended as hadronic fuel for ICFP because ICFP used on hydrogen is expected to cause the production of neutrons that notoriously propagate through shielded walls, by therefore cause harmful radiations. A goal of ICFP is to produce energy without the emission of such harmful radiations.

A number of alternatives to process (1) are possible under the verification of Principles 1 to 5, such as those based on Electron Capture (denoted EC), Electron Emission (denoted EE) and other intermediary processes that lead to a final light, natural and stable nucleus without the emission of harmful radiation and without the release of radioactive waste. Note that EE is not considered harmful to humans since electrons can be stopped with a thin metal shield. Electrons cannot escape outside the heavy metal vessels of the apparatus that is disclosed.

We solely consider, herein, the axial triplet coupling of nuclei as depicted in FIG. 3, in which case the conservation of the angular momentum requires that the angular momentum of the synthesized nucleus is the sum of the angular momenta of the original two nuclei. This is necessary for the ICFP because of the structure of magnecular coupling as per FIG. 4 which is a necessary pre-requisite for the ICFP as explained above. In the event nuclei 17 are coupled in the planar singlet coupling of FIG. 5, the conservation law of the angular momentum requires that the angular momentum, of the synthesized nucleus is the difference between the angular momenta of the two original nuclei. The latter coupling of FIG. 5 is not considered in the ICFP studied below since, in the planar singlet coupling, the toroid polarization of the orbitals prohibits nuclei to be bonded by a trigger at mutual distances of one Fermi or less.

The following conversions of various units are reviewed for use below:

$$\begin{matrix}1 u = 931.494 MeV ; \\ \begin{matrix}1 MeV = 1.602 \times {10}^{- 13} J = \\ = 4.45 \times {10}^{- 17} Wh \\ = 1.511 \times {10}^{- 16} BTU ;\end{matrix} & ( 2 a ) \\ 1 Wh = 3.397 BTU ; 1 C = 6.241 \times {10}^{18} e ; 1 A = 1 C / 1 s , & ( 7.2 b )\end{matrix}$$

where e is the elementary charge. Recall that a representative apparatus of this invention is characterized by a DC electric arc powered, for example, by a typical 50 kW AC-DC converter. 50 kWh is approximately 1.69 10⁵ BTU. To have utility as well as consumer and industrial value, an implementation of ICFP must produce energy well in excess of 1.69 10⁵ BTU. Note that light elements, such as hydrogen and helium, are expected to be completely ionized, at least in part, under a 50 kW DC arc, represented as H=p and He=α.

Exemplary ICFP equations verifying Principles 1 to 5 and providing an energy output with utility, consumer and industrial value are given by processes synthesizing nitrogen via the use of deuterium (also known as heavy hydrogen) and carbon as hadronic fuels according to the law:

D(2,1,1⁺,2.0141)+C(12,6,0⁺,12.0000)+TR→→N(14,7,1⁺,14.0030)+ΔE, (3a)

ΔE=(E_{C}+E_{H})−E_{N}=0.0111u=10.339 MeV≈1.5 10⁻¹⁵ BTU (3b)

where D denotes deuterium. As described in details later, the above ICFP is performed in a pressure vessel containing deuterium gas traversed by a DC arc between carbon electrodes. The ICFP essentially occurs at atomic distances from the DC arc. The electrodes release carbon atoms and a population of magnecules forms between polarized deuterium and carbon atoms denoted with the symbol D×C with symmetry axis tangent to the circular magnetic force line around the DC arc as illustrated in FIG. 2. The D and C nuclei are at mutual distances of 1 Fermi or less. The trigger then forces the D and C nuclei together, at which point strongly attractive nuclear forces are activated and the fusion of D×C into N is performed. As shown below and in the underlying experimental verifications, a typical apparatus implementing ICFP operates at around 3,000 psi pressure. At this pressure, a vessel contains about 10²⁵ deuterium atoms per cubic foot. Consequently, a very modest rate of 10⁶ ICFP per hour, results in the production of energy of about ten times the electric energy provide to the arc. A rate of 10³⁰ ICFP per hour, which is fully within current technological capabilities of the apparatus described, produces around 10¹⁰ BTU per hour compared with the electric energy consumed which is equivalent to 1.69 10⁵ BTU. This energy production occurs without the emission of harmful radiations and without the release of radioactive waste. The fact that nitrogen is synthesized indicates that there cannot be any possible release of harmful radiation. Calculations then confirm that it is impossible for ICFP (3) to release radioactive waste due to the extreme energy insufficiency of the 50 kW power for the disintegration of light, natural and stable nuclei. Such a disintegration is necessary for the release of radioactive waste. These data and features show the novelty, as well as utility, consumer and industrial values of ICFP.

Another ICFP of particular novelty, utility, consumer, industrial and environmental values is given by the use of a hadronic fuel of the green house gas CO₂. This gas, CO₂ is produced by many devices contributing to global. It is beneficial to the ecology to turn this source of major environmental problems into a source of clean energy. In ICFP, not only energy is produced but a gas is reduced that, in excess, is not good for the environment.

It is conjectured that a DC arc is one of the most effective means for molecular separation. As a consequence, the DC arc between suitably selected electrodes, as specified below, when traversing a CO₂ gas that is under high pressure, causes the separation of the CO₂ molecules into two oxygen and one carbon atoms. As with a typical DC arc, once CO₂ is broken down into C and O, we normally have a combustion triggered by the arc itself of C and O into CO and then of CO and O into CO₂ with the release of 288 kcal/mole and 89 kcal/mole, respectively. The difference in ICFP being the trigger, under which the arc creates the C×O magnecule that is turned into the ICNF of silica according to the law:

O(18,8,0⁺,17.9991)+C(12,6,0⁺,12.0000)+TR→→Si(30,14,0+,29.9737)+ΔE (4a)

ΔE=0.0254u=4.32 10⁻¹⁵ BTU. (4b)

The 377 kcal/mole produced by the combustion of C and O into CO and CO₂ is smaller than the electric energy used for the original separation of CO₂ into C and O due to understood losses. Therefore, without ICFP, the combustion of C and O produced by the arc is insufficient for the production of energy from the separation and then the recombination of CO₂. However, the energy released in the fusion of C×O into Si is about one thousand times more than the separation energy of CO₂ into C and O. Consequently, the apparatus of ICFP provides for the use of the green house gas CO₂ as a source of clean energy.

As described previously, in some embodiments, ICFP (4) is performed between DC arcs between carbon electrodes that, as such, provide additional carbon atoms needed for the fusion process. However, in other embodiments ICFP (4) is performed using non consumable electrodes, such as toriated or other forms of tungsten, since the carbon needed for the fusion process is provided by the separation of the CO₂ molecule.

Atmospheric air is also anticipated as hadronic fuel. Oxygen is naturally available in this hadronic fuel, thus avoiding the loss of energy for molecular separation. Therefore, the use of air as hadronic fuel produces at least 377 kcal/mole more energy than the energy produced by using CO₂ as hadronic fuel. Additionally, the nitrogen content of air allows additional ICNF besides processes (4), thus confirming the larger energy output that can be obtained by using atmospheric air as hadronic fuel. Despite this greater utility, the use of atmospheric air as hadronic fuel is not recommended due to the production in this case of the green house gas CO₂ as part of the processes involved in the ICFP, while the use of CO₂ as hadronic fuel implies its progressive elimination and conversion into silica, with evident, distinct, environmental advantages.

A third representative example of ICFP is given by the use as hadronic fuel of a 50-50 mixture of deuteron and helium gases traversed by a DC arc with ensuing processes:

H(2,1,1⁺,2.0141)+He(4,2,0⁺,4.0026)+TR→→Li(6,3,1⁺,6.0151)+ΔE (5a)

ΔE=0.0016u≈2.5×10⁻¹⁶ BTU. (5b)

Hence, when producing about 10³⁰ ICFP per hour, the above ICFP yields an hourly production rate of about 10⁹ BTU per hour, namely, an energy output of about one thousand times the used energy. An example of ICFP with admissible intermediary processes is given by the synthesis of the following unstable iron isotope via the use of oxygen and deuterium as hadronic fuel:

O(16,8,0⁺15.9949)+H(2,1,1⁺,2.0141)+TR→→F(18,9,1⁺,18.0009)+ΔE, (6a)

ΔE=0.0081u=7.545 MeV. (6b)

with intermediate decay:

F(18,9,1⁺,18.0009)+EC→O(18,8,0⁺,17.9991)+ΔE, (7a)

ΔE1.656 MeV, (7b)

resulting in the following total energy output per synthesis:

ΔE=9.201 MeV≈1.30 10⁻¹⁵ BTU, (8)

in which case, 1030 syntheses per hour yield a new clean energy with distinct utility, consumer and industrial value. At this point it is important to identify the novelty and utility of this invention with respect to the cold and hot fusions. A typical reaction extensively studied for the cold fusion is that of two deuteron into the helium according to the process:

H(2,1,1⁺,2.0141)+H(2,1,1⁺,2.0141)→→He(3,2,½⁺,3.0160)+n (9)

that implies the necessary emission of very harmful neutron radiations.

Radiations are absent in the ICFP, thus establishing ICFP's novelty, consumer and industrial values beyond doubt. Additionally, in engineering the implementation of reaction is difficult due to the need for the deuterium nuclei to have opposite spin polarization as a necessary condition to verify the conservation of the total angular momentum. In the absence of this, no scientific credibility or utility is possible. In fact, the original nuclei both have spin 1, with total spin 2, while the total spin of the final state is 1. These opposite polarizations are absent in the ICFP, thus illustrating again the distinct increased utility and industrial value.

The difference between pre-existing studies on cold fusion and the ICFP is also illustrated by an example in which the apparatus is filled up with hydrogen, and the electrodes are made up of palladium 106. In this case, fusions are predicted inside the palladium cathode according to the rules:

Pd(106,46,0⁺,105.9034)+H(1,1,½⁺,1.0078)→→Ag(107,47,½⁺106.90509) (10)

The above reaction does verify conventional conservation laws. However, the engineering implementation of the synthesis inside the palladium electrodes is very difficult if not impossible, thus explaining the lack of achievement of utility and industrial value by prior cold fusions experiments, in the absence of the systematic and controlled verifications of basic laws, fusions have been believed to occur at random.

The advantages, utility, consumer, industrial and environmental benefits of ICFP over hot fusions are evident. In fact, the engineering difficulties in containing the plasma at extreme energies required by hot fusion have prevented the achievement of any utility to date by hot fusion. These difficulties are absent in the ICFP.

It is important to point out the existence of certain ICFP that do verify all principles and conservation laws, but are not recommended for actual use because they release harmful radiations. The best illustration is given by the use of hydrogen and carbon as hadronic fuels for the synthesis of nitrogen that is predicted to release harmful neutron radiations. In fact, as shown in details in HMMC, Volume IV, neutrons are synthesized in a hydrogen gas traversed by a DC arc according to the known reaction:

p+e→+v, where v is a neutrino.

Consequently, in the use of hydrogen and carbon as hadronic fuel, the synthesis of neutrons is expected, part of which are emitted as harmful radiation and part are absorbed by hydrogen nuclei to synthesize deuterium according to the rules:

C(12,6,0)+2H(1,1,½⁺,1.0078)+TR→C(12,6,0)+D(2,1,1⁺,2.0141)+n+v→→N(14,8,1)+n+v+ΔEm (11)

showing the expected production of usable energy but also the emission of harmful neutron radiations. Consequently, hydrogen is not recommended as a hadronic fuel for the ICFP of this invention.

Another ICFP yielding harmful radiation is given by the use of hydrogen and lithium as hadronic fuel:

Li(7,3,3/2⁻,7.0160)+H(1,1,½⁺,1.0078)+TR→→2He(4,2,0⁺,4.0026), (12a)

ΔE=2.887×10⁻¹²J (12b)

As one can see, the energy output of this ICFP is greater than that of preceding fusion processes. Nevertheless, the above synthesis produces two alpha particles that constitute harmful radiation and, consequently, the above ICFP are not recommended for use, unless the apparatus is shielded such to prevent the propagation of said alpha particles into the environment.

Numerous additional ICFP candidates are anticipated using the principles disclosed and the tabulated data on nuclides as above. The identification of these additional processes is left to those the skilled in the art.

Substantiation of the above is based upon extensive tests and experimental verifications of the ICFP spanning around two years. The results of these tests are reported below and are available.

As an exemplary verification of ICFP, the synthesis of nitrogen from deuterium and carbon according to process (3) above has been used. This verification was selected over several others to avoid potential controversies predicted if the selected fuel had a partial energy contribution due to combustion, as it is the case of CO₂. In fact, no combustion is remotely possible in a pure deuterium gas traversed by a DC electric arc between carbon electrodes. Consequently, any energy produced in excess over the energy used establishes the existence of ICFP (3).

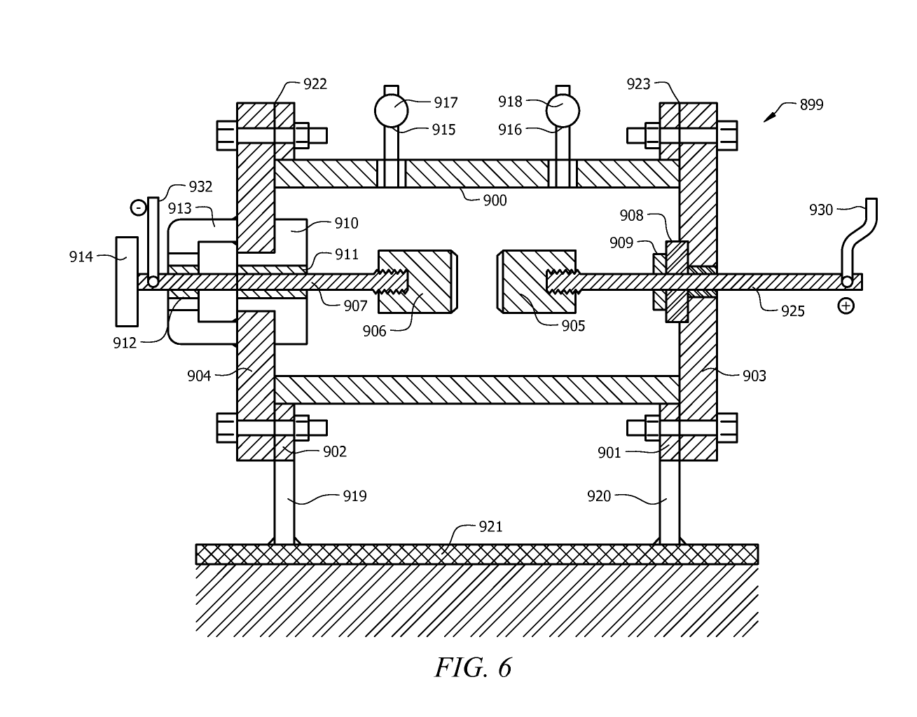

The experiment uses an exemplary apparatus 899 as shown in FIG. 6. The apparatus 899 consists of a schedule 40 steel pipe 900 having, for example, 1 ft diameter and 2 feet length completed with welded on hollow flanges 901, 902 and gaskets 922, 923 on both ends and bolted on flanges 903, 904 also on both ends. The vessel 899 contains, in its interior, two commercially available graphite electrodes 905, 906 having, for example, 2″ diameter and 3″ length. The electrodes are fastened to 0.5″ copper shafts 925, 907 protruding outside of the flanges 903, 904 for connection via the plus polarities 930 and minus polarities 932 to corresponding polarities of a source of power which, in this experiment is a 50 kW commercially available AC-DC converter such as that manufactured by Miller Electric Company (not shown in FIG. 6) as known in the art. Electrode 905 is stationary and insulated from the flange 903 by, for example, a phenolic bushing 908. The copper rod 925 has an edge 909 assuring that electrode 905 is not pushed toward flange 903 by internal pressure. The phenolic bushing 908 insulates as well as seals, maintaining pressure inside pipe 900 via cement or other sealing means as known in the industry. Electrode 906 is also insulated from flange 904 by a phenolic bushing 910 that contains in its interior a series of seals 911 allowing the copper rod 907 to slide in and out along its axis while maintaining the pressure inside the vessel 899. Copper rod 907 is equipped with a threaded part 912 outside of flange 904 that is matched by a corresponding threaded component of a fastener 913 that is affixed (e.g. welded) to flange 904. An insulating wheel 914 (e.g. phenolic) is fastened at the end of copper rod 904 in such a way that the rotation of wheel 914 to the right or to the left moves the electrode 906 toward or away from the fixed electrode 905 in order to manually establish, maintain and extinguish the DC arc.

The apparatus of FIG. 6 is further equipped with two inlet-outlet ports 915, 916 with valves 917, 918, for generating a vacuum inside the vessel 899, for filling the vessel 899 with the deuterium gas, and for taking samples for analyses. The apparatus 899 is finally completed with supports 919 and 920 fastened to hollow flanges 901 and 902 and welded on metal base 921 providing the necessary stability.

Experimental verifications of ICFP (3) was conducted via the following procedure. First, the vessel 899 is evacuated 6. Subsequently, said vessel 899 is filled to 100 psi with deuterium gas (e.g., deuterium gas supplied by Advanced Special Gases of Reno, Nev. and guaranteed by the producer as being 99.99% pure). A two-valve laboratory bottle marked HT1 is filled with the gas in the interior of said vessel following appropriate flushing. This provides analytic measurement of the deuterium gas plus an expected small amount of impurities originating from the interior of the vessel. The DC arc is then activated at 40 kW for two minutes, at which point the arc is disconnected because excessive heat is produced in the interior of the vessel. A second two-valve laboratory bottle marked HT2 is filled from the gas in the interior of the vessel following this activation of the arc. The two laboratory bottles are then analyzed for gas content, showing the result of the process. Radiation counts during the test are done by 1) a photon-neutron detector (e.g., model PM1703GN manufactured by Polimaster, Inc., with sonic and vibration alarms as well as memory for printouts), with the photon channel activated by CsI and the neutron channel activated by LiI; 2) a photon-neutron detector (e.g. SAM 935 manufactured by Berkeley Nucleonics, Inc.), with the photon channel activated by NaI and the neutron channel activated by He3 also equipped with sonic alarm and memory for printouts of all counts; 3) a BF3 activated neutron detector (e.g. model 12-4 manufactured by Ludlum Measurements, Inc.) without counts memory for printouts but with both visual and sonic means; 4) an alpha, beta, gamma and X-ray detector (e.g. model 907-palmRAD manufactured by Berkeley Nucleonics, Inc.), and 5) various material suitable for nuclear transmutations. These devices indicated that no radiations were detectable outside the vessel 899 during all tests, with particular reference to the absence of neutrons that, if produced, would indeed be detectable outside the vessel. This confirmed the production of usable energy without any release of harmful radiation. Radiation detection following the tests and the opening up of the vessel of FIG. 6 confirmed the complete absence of any radioactive waste, thus establishing the production of usable heat without harmful radiations or radioactive waste.

Internally produced electrons were not measured because they are absorbed by the Schedule 40 metal walls of the vessel without being detected outside of the vessel 899. No production of alpha particles is possible for the ICNF here considered due to extremely insufficient energies for the fission of the light stable nuclei.

Commercially available digital sensors were used for the recording of temperatures. Related measurements were done as follows. With reference to FIG. 6, pipe 900 and welded hollow flanges 901 and 902 had the tabulated weight of 325 lbs confirmed by actual measurements, plus the weight of the steel in the four welds. To be conservative, the weight of this assembly 899, hereon referred to as the cylindrical component, is of 300 pounds. Additionally, the apparatus includes two plain flanges 903/904 each having a tabulated and actually verified weight of 189 lbs. However, these flanges are thermally isolated from the cylindrical component by gaskets 922, 923 necessary to maintain a constant pressure in the interior. In fact, systematic heat measurements showed that the cylindrical component would acquire heat much faster and in much greater amounts than the terminal flanges. To be conservative, the experiment only considered the heat gained by the cylindrical component.

The tests on deuterium gas at 100 psi with a 40 kW DC arc between carbon electrodes operated for two minute and showed a systematic increase in temperature from the ambient temperature in the range of 20 degrees C. to generally over 150 degrees C. with a conservative average of about 127 degrees C. The use of the known expression for the specific heat of commercial grade carbon steel pro-rated to the measured data as follows (449 J/kg C 136:077 kg×127 C)/(1055.06 J/BTU) yields the heat acquired by the cylindrical component:

ΔEcc=7404 BTU (13)

By recalling the known value 1 kWh=3400 BTU, the use of 40 kWh for two minutes yields the heat generated by the arc:

ΔEarc=4533 BTU (14)

Consequently, the internal reactions produced the net heat in two minutes of:

ΔEout=2,871 BTU (15)

Since no other source of energy/heat is present, this proves the existence of a significant internal source of energy beyond that of the AC-DC converter.

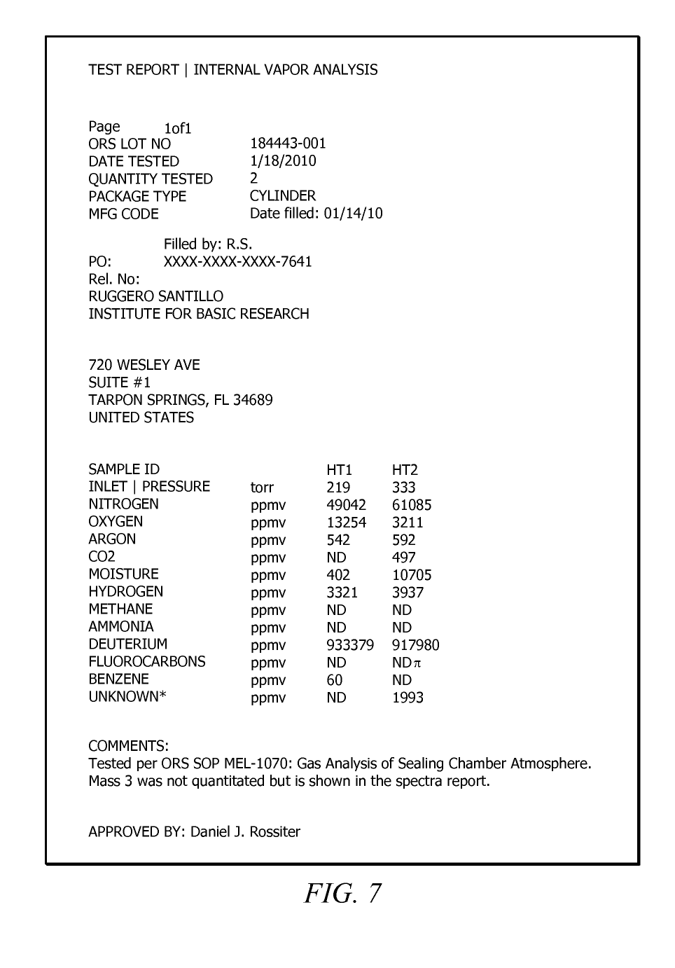

The chemical analyses of samples HT1 and HT2 are shown in FIG. 7. During the two minutes of operation of the arc, the deuterium gas decreased in a macroscopic amount from 93.3% to 91.8% while nitrogen increased in a macroscopic amount from 4.90% to 6.11%. By comparison, oxygen was contained only in microscopic ppmv parts, thus being unable to represent that the heat was produced via conventional combustion. These data establish beyond possible scientific doubt by the existence of the nitrogen synthesized from deuterium and carbon according to ICFP (3).

Following the above reviewed experimental verifications, the inventor requested an independent repetition of all experiments and related measurements by three nuclear physicists, R. Brenna, T. Kuliczkowski and L. Ying of Princeton Gamma-Tech Instruments, Princeton, N.J., who confirmed, in full, the existence of ICFP (3) as presented above, with particular reference to the production of significant energy over the amount of energy used without the emission of any harmful radiation or the release of any radioactive waste. The analysis by said nuclear physicists is available for review. In any case, R. Brenna, T. Kuliczkowski and L. Ying are writing a scientific paper with a detailed presentation of all results that will be published in a refereed journal. An additional detailed technical review of the independent confirmation of ICFP is available in the Gandzha-Kadeisvili monograph scheduled for appearance in mid 2011. The above identified experimentalists, under the leadership of Leong Ying, used the same experimental set up as depicted in FIG. 6. All tests were performed independently. As above, the objective was the verification of ICFP (3) for the synthesis of nitrogen via the use of deuterium and carbon as hadronic fuel.

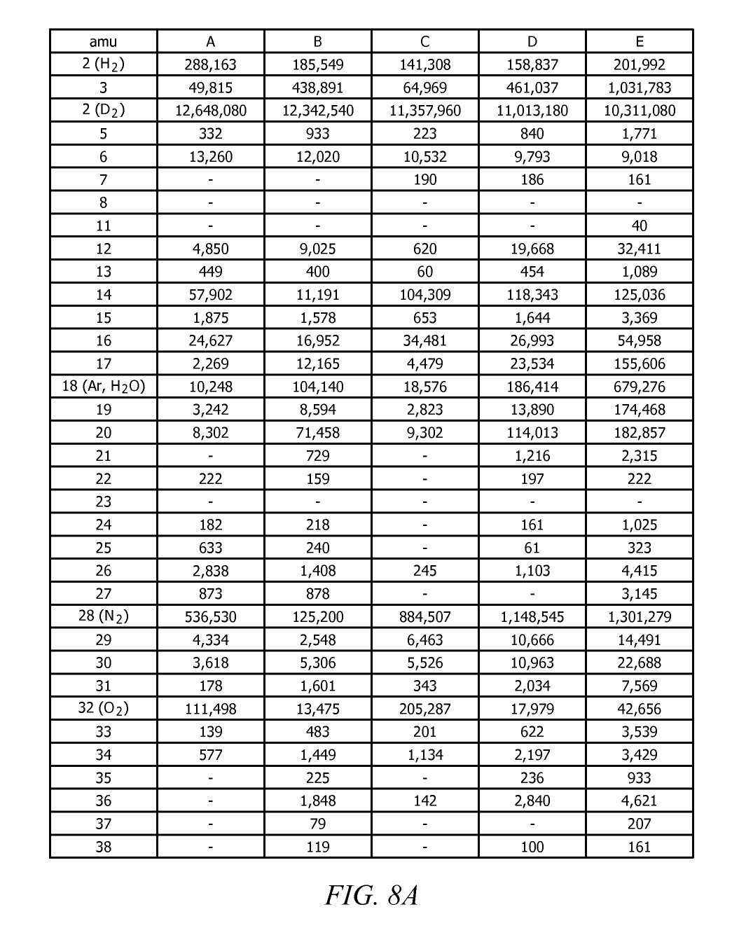

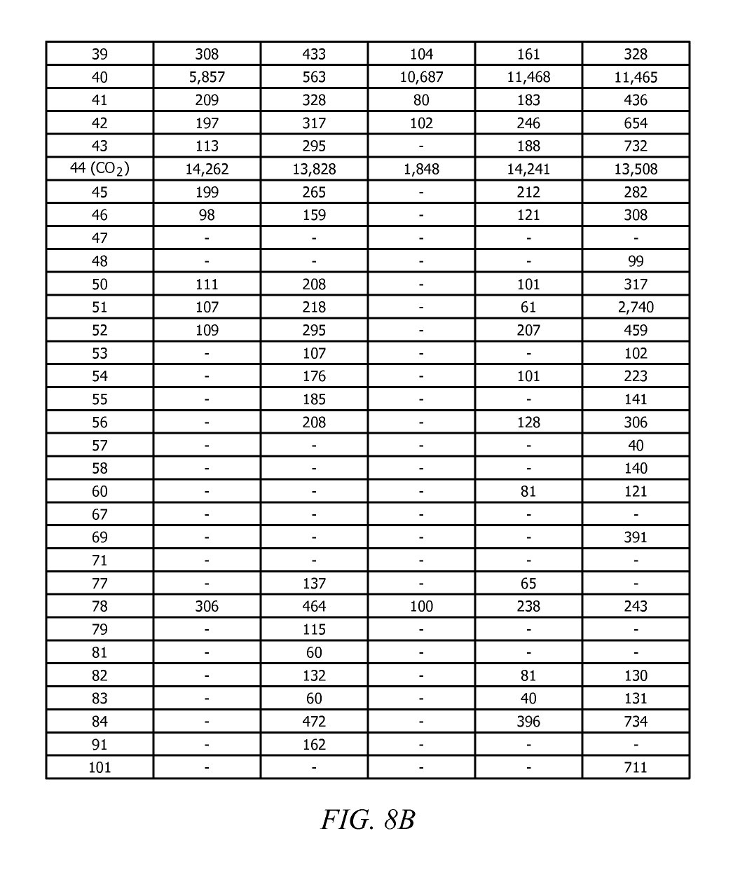

As with the initial experiments, the apparatus was pressurized with pure deuterium gas following air removal with a mechanical vacuum pump. Gas samples were taken before and after each initiated reaction and the samples sent to an independent laboratory for spectra vapor analysis. Each experimental run was started close to ambient temperature of nominally 25 degrees C., with the electric arc powered for 2 minutes. An industrial wattmeter measured an average power consumption of 1550 Wh, which equates to an energy input of 5.4 MJ. A total of 3 runs were performed at varying starting pressures of 100, 75 and 50 psi. For the 100 psi tests, gas samples before (A) and after (B) were taken. The apparatus chamber was then purged, refilled with pure deuterium gas, and a gas sample (C) was taken at a starting pressure of 75 psi. After the reaction process at 75 psi, a gas sample (D) was extracted. The apparatus was then allowed to cool back to ambient temperature, the pressure reduced to 50 psi for another reaction. Note that pure deuterium gas is non-combustible, being that the very small presence of oxygen is negligible. Hence, in the absence of ICNF, one would expect to observe similar vapor spectra for the samples taken before and after initiation by the electric arc. The analyzed spectra for the 5 gas samples, the reported values in parts-per-million indicated as ppm by volume were accurately reported in FIGS. 8A and 8B. These spectral analyses confirm a reduction in the amount of deuterium following each activation of the DC arc. At 100 psi the decrease is approximately of 2.5%, and at 75 psi it is 3%. The decrease in the amount of nitrogen in the 100 psi data is misleading, since the evolved nitrogen is typically trapped in clustered magnecules as indicated by the existence of higher mass entities in the spectral data following all the reactions. These previously unknown higher mass magnecules are further evidence of the ICFP taking place. Samples of deposits on the surface of the graphite electrodes were removed for material characterization in a Scanning Electron Microscope using an Energy Dispersive Spectroscopy X-ray detector. The detector is a nitrogen cooled lithium-drifted silicon crystal biased to operate as a semiconductor junction. X-rays liberate electron-hole pairs in the junction, and the amount of charge collected is proportional to the X-ray energies. The electron beam striking the samples generates electronic excitation, and it is the decay of these electronic shells that emits the characteristic X-ray energies unique to each element. The elemental microanalyses spectra taken on the surface deposits of the graphite electrodes show a prominent X-ray peak at 277 eV identifying carbon. There is a small adjacent peak at 392 eV, which is the nitrogen X-ray that is noticeable above the general background level. Since the detector chamber is under vacuum, then the detected nitrogen must exist in some non-gaseous magnecular form. Platinum resistive temperature sensors were securely fastened to the surfaces of the steel chamber's central tube and one of the end plates. Temperature readings were noted after the electric arc was powered to produce the thermal properties of the apparatus. A thermal Finite Element Analysis was simulated for the reactor to estimate the expected temperature rise if the only source of heat came from the electric arc. Comparison curves of the measured thermal profiles against the computed values at 5 MJ, 5.5 MJ and 6 MJ energy inputs are shown below.

The data indicate the generated excess heat of approximately 0.5 MJ above the total injected energy input of 5.4 MJ of the electric arc. From ICFP (3) we know that each reaction releases around 10 MeV of energy. Therefore, if we assume all of the excess heat is from the ICNF process, then this is equivalent to the generation of a micro-mole of fusion products. The absence of harmful radiations outside the apparatus of FIG. 6 was tested with a variety of detectors, including a sodium iodide scintillator detector (e.g., SAM940) which is self-calibrating at the potassium 40K energy of 1.461 MeV. The 3He proportional counter was factory calibrated against a californium 252 Cf neutron source. For safety and security reasons, the source is embedded in wax and locked inside a steel vault. By opening the vault door and placing the SAM940 instrument approximately a meter from the source, the experimentalist were able to detect average neutron levels of 0.8 counts per second denoted cps.

With the vault door closed and the instrument removed from the vicinity, the background levels fell to less than 0.03 cps. Compared to normal background levels, there were no emitted gamma-rays or neutrons detected emanating from the apparatus during all tests on ICFP. In conclusion, the tests by L. Ying and his collaborators confirm ICFP, namely: 1) Due to the lack of any possible combustion in a metal chamber filled with pure deuterium gas traversed by a DC arc between carbon electrodes, the excess energy detected by the experimentalists over the energy of the DC arc is produced by ICFP (3). 2) Systematic measurements conducted with various detectors have confirmed that no harmful radiation of any type was detected in any of the tests outside the apparatus 899, thus confirming ICFP occurs without the emission of neutron or other harmful radiation. Additional inspections of the interior of the apparatus following the tests confirmed the absence of any harmful waste. 3) Examination of the chemical analyses of the deuterium gas before and after being traversed by the DC arc establishes the creation in the latter case of new heavy chemical species detectable all the way to 400 amu some of which are detected in macroscopic percentages. These new heavy species cannot possibly exist in a pure deuterium gas. Also, these new species are much heavier than the original deuterium gas. Finally, the new heavy species cannot possibly be fragments of ordinary molecules. Consequently, the new heavy species are magnecules, thus confirming a main mechanism at the foundation of ICFP as elaborated above.

As indicated above, ICFP occurs at atomic distances from the electric arc. It is then evident that fusion processes create disruptions in the arc itself at the time of their occurrence. To achieve utility, consumer and industrial values, continuous removal of newly synthesized nuclei from the arc immediately following their synthesis is needed. This objective is achieved by providing a flow of the gaseous hadronic fuel through the arc itself, so as to continuously expose the arc to a new gas and, in so doing, remove the processed gas and synthesized nuclei. Several flow configurations are anticipated. A first configuration is that in which the flow of the gas is essentially but not necessarily perpendicular to the arc. A second configuration is that in which the flow of the gas is along the direction of the arc. The former process is called PlasmaArcFlow and denoted PAF, while the latter process is called PlasmaArcThrough and denoted PAT. These flows have been previously used for the flow of liquids through an arc. Such prior use of PAF and PAT to flow a liquid through an arc were specifically and solely intended for the production of a clean burning, cost competitive, gaseous fuel that has been commercially sold under the name of Magnegas. In contrast the PAF and PAT configurations are used with ICFP for the flow of a gas through an arc for the production of heat.

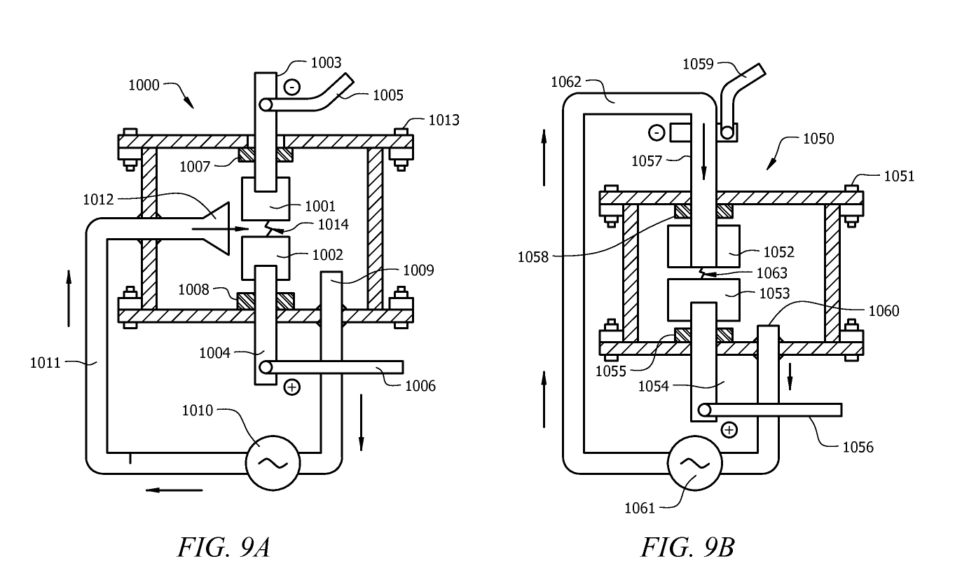

A detailed engineering and manufacturing description of the PAF and PAT processes is provided below. With respect to FIG. 9A, a schematic characterization of the PAF process is given by a pressure metal vessel 1000 fabricated, for example, with commercially available pipes, welded-on hollow flanges, and plain flanges with related fasteners 1013 such as bolts 1013, sealed to maintain pressure. The vessel 1000 contains in its interior electrodes 1001/1002 between which an arc 1014 essentially occurs in the gas between the electrodes 1001/1002 essentially along the axis of symmetry of the electrodes. The electrodes 1001/1002 are equipped electrically and physically connected to rods 1003/1004 that protruding outside vessel 1000 via insulating bushings 1007, 1008. The rods 1003/1004 are connected to positive and negative sources of electrical power by cables 1006/1005, respectfully. The source of electrical power is typically a high-voltage DC source (not shown) as known in the industry. A pump 1010 removes the gaseous hadronic fuel from the interior of vessel 1000 through a port 1009 and compress the gaseous hadronic fuel in the directions shown through pipe 1011 and presents the gaseous hadronic fuel back into the chamber 1000 through a funnel type orifice 1012 that faces and is oriented in the immediate vicinity of the electrodes 1001/1002 in such a manner that the flow of the gaseous hadronic fuel is forced over the entire electrode gap and the gas traverses the arc 1014 in a direction essentially perpendicular to the arc. Additional embodiments of this apparatus are anticipated that achieve commercial utility, consumer and industrial value as described below.

With respect to FIG. 9B, a schematic description of the PAT process will be described. The apparatus 1050 is similar to the apparatus 1000 of the PAF process in that it is comprises a pressure vessel 1050 made, for example, from commercially available pipes, welded on hollow flanges, and plain flanges with related fasteners 1051 such as bolts 1051 to maintain pressure. In the interior of the vessel 1050 is a cathode 1053 that is electrically and physically attached to a conducting rod 1054 that protrudes outside vessel 1050 through insulating bushing 1055 for connection to a positive cable 1056 from a DC power source (not shown). The interior of the vessel 1050 also contains an anode 1052 having one or more bores 1057 preferably through a symmetry axis of the anode 1052. The bores 1057 are interfaced to a conducting tube 1062 protruding outside of the vessel 1050 through insulating bushing 1058 and the conducting tube 1062 is connected to a negative cable 1059 that provides the negative polarity of the DC power source. Internal gaseous hadronic fuel is extracted by a pump 1061 from a port 1060 and compressed such that, said gaseous hadronic fuel is pumped through the bores 1057 and into the electrode gap in a direction essentially but not necessarily along the direction of arc 1063.

The selection for a given embodiment of the PAF or the PAT process depends on the selected chemical composition of the electrodes. Consider first the case in which the gas contains all needed hadronic fuel. In this case, the electrodes do not contribute to the ICFP, and the electrodes are composed of non consumable temperature resistant conductors, such as toriated tungsten. Under these conditions, the PAF process is generally, but not necessarily preferred over the PAT process for a number of reasons, such as the cooling down of the electrodes permitted by the geometry of the PAF process. Consider then the case in which the electrodes themselves are part of the needed hadronic fuel, thus being consumable. This is the case for the synthesis of nitrogen from deuterium and carbon as in ICFP (3). In this case the gas is solely composed of deuterium while the needed carbon is provided by graphite electrodes. Under these conditions, the PAT process is generally, but not necessarily, preferred over the PAF process because the particular configuration of the PAT process of FIG. 9B facilitates the extraction by the arc of carbon atoms from the anode, and the configuration causes impact of the magnecules surrounding the arc against the carbon cathode, thus facilitating the production of ICFP.

An second requirement to achieve novelty, utility, consumer, industrial, and environmental values is the engineering realization of the trigger. ICFP are created by sudden variations of DC arcs, such as during the phase of initiation or extinguishing of the arc. Hence, ICFP do not generally occur at the atomic distances of a stationary DC arc. One trigger is a mechanism that breaks the stability of the arc. Therefore, a first realization of the trigger is achieved via the use of pulsed DC arc with voltage of the order of 100,000 V and pulse frequencies of the order of 10⁷ Hz. In such embodiments, it is preferred, though not required, that the frequency is a submultiple of a resonating frequency of the target gas. A second embodiment of the trigger is given by a way to destabilize the DC arc, such as rapidly varying resistors included in the power line connecting the arc to the DC power source. A third embodiment of the trigger is given by providing a rapid increases of pressure in the vessel that facilitates ICFP, such as the fusion of the deuterium-carbon magnecule D×C into nitrogen N.

To achieve utility, consumer, industrial and environmental value, the achievement of a control of ICFP is needed. Such a basic requirement is implemented in a variety of ways usable individually or collectively for increased utility. These include, but not limiting to:

I) Control of the electric power. Since all possible ICFP cease to exist at the disconnection of the power, production of energy is ended immediately after the arc is switched off. Additionally, the increase or decrease of the power during operations allows the increase or the decrease of the produced energy as desired.

II) Control of the flow. Experimentation has established that an electric arc between electrodes submerged within a gas is extinguished for a given excess flow under a given power. Therefore, in the event of the failure of other controls, ICFP can be terminated by increasing the flow of the gas through the electrodes until the arc is extinguished. Additional control is given by increases or decreases of the flow during normal operations that leads to corresponding increase or decrease of the produced energy.

III) Control of the trigger. As soon as the trigger mechanism is turned off, the arc acquires a steady configuration, in which case only conventional chemical reaction generally occur within the plasma of the arc.

Comparison to Prior Plasma Arc Technology:

A) ICFP is centered in the synthesis of nuclei, while Plasma Arc Technology is centered in the absence of any nuclear synthesis. No fusion process in Plasma Arc Technology. Plasma Arc Technology uses a stationary arc submerged within a liquid. Plasma Arc Technology processes for liquids traversed by stationary and stable arcs produce a total energy output greater than the used electric energy, but the excess energy is of chemical nature and essentially due to carbon combustion in the plasma of the arc characterizing very esoenergetic chemical reactions. For instance, for the case of a DC arc between carbon electrodes submerged within water, we first have the separation of the water molecule and the formation of a plasma composed of mostly ionized atoms of carbon, oxygen and hydrogen at 5,000 degree C., with ensuing high esoenergetic reactions, such as: the creation of CO with the release of 288 kcal/mole; the creation of H2 with the release of 110 kcal/mole; the creation of CO2 with the release of 89 kcal/mole; the creation of H₂O with the release of 57 kcal/mole; and other esoenergetic reactions. No nuclear fusion has been detected in the PAF and PAT processes in liquids.

B) The physics and chemistry of arcs submerged within a gas of ICFP are dramatically different than the arcs submerged within liquids as per Plasma Arc Technology. In ICFP, arcs are activated at a distance via a Tesla coil or other means, while the Plasma Arc Technology arcs have are activated by a short. The electric resistance of a gas is, in general, a small fraction of the electric resistance of liquids such as water and other factors.

C) ICFP deals with the production of usable heat, while Plasma Arc Technology deals with the production of a combustible fuel.

D) Electric arcs of ICFP are preferred to be unstable as a condition to optimize the production of heat, while the electric arcs of Plasma Arc Technology are preferred to be stable as a condition to optimize the production of combustible fuels.

ICFP uses a pressure and temperature resistant metal vessel, also called a hadronic reactor, filled with a gas called hadronic fuel. In the interior of the vessel is at least one submerged electric arc between a pair of temperature resistant electrodes powered by a source of DC voltage (e.g. an AC-DC converter) wherein the vessel is equipped with various means including: means for delivering an electric current to said electrodes; means to optimize ICFP called a trigger; electronic means for the automatic and remote initiation, maintenance and optimization of the electric arc; means for the automatic and remote collection and utilization of the produced heat acquired by the gas; cooling means for the automatic and remove maintaining of the vessel at constant temperature; means for the automatic and remote refilling of the vessel with the selected hadronic fuel; monitoring means for the automatic halting of all operations in the event of any malfunction or irregular values of pressure, temperature, flow and other features; means for the variation of the produced heat within pre-set limit as desired; means for the automatic paging of the operator in the event of a malfunction and other means; all said means being described in all possible, minute, conceptual, technical and manufacturing details in the specifications below.

As a numerical illustration with a small power and moderate operating pressure, a PAT hadronic reactor containing deuterium as hadronic fuel at the pressure of 300 pounds per square inch (psi) and powered by 50 KW AC-DC converter delivering an arc between graphite electrodes, trigger realizes via an in line computer operating resistors with rapidly varying resistance absorbs about 55 Kwh including the pumps corresponding to about 180,000 British Thermal Units per hour (BTU/h) in used electricity. Jointly, this apparatus produces abut 2,000,000 BTU/h of heat as acquired by the metal vessel as well as by the deuterium gas, thus producing usable energy of more than 10 times that of the energy used. The efficiency of hadronic reactors is however predicted to increase with the increase of the pressure, as well as other factors, such as the efficiency of the trigger. As an example, the same reactor as above with the same 50 AC-DC converter and trigger, but operated at 3,000 psi is predicted to produce energy of around 100 times that of the energy used.

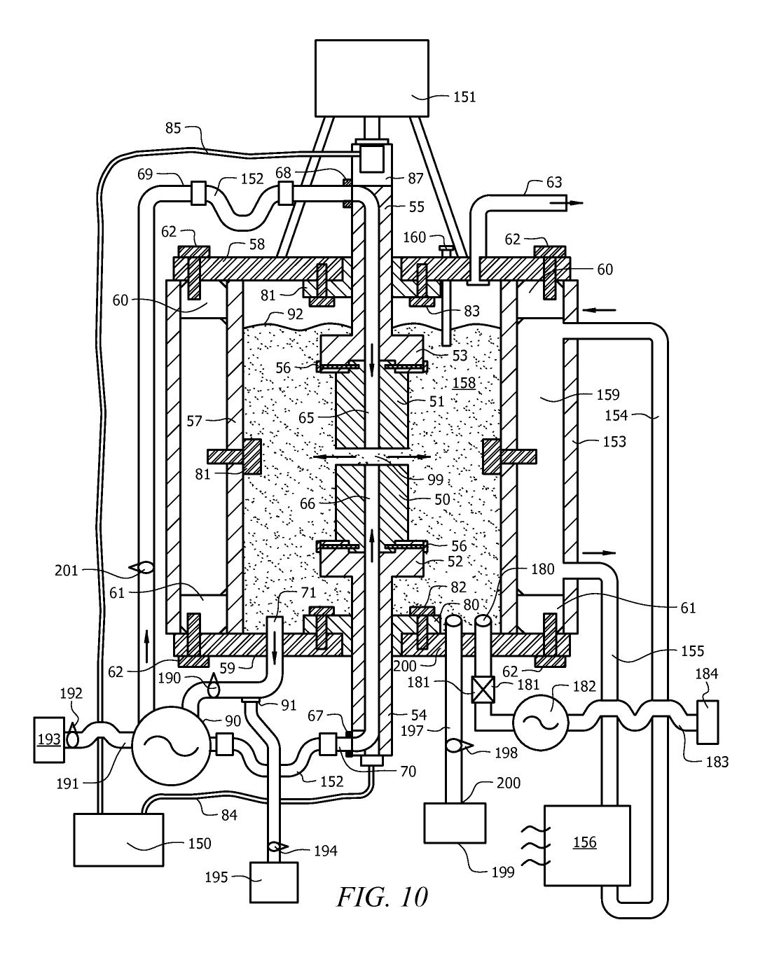

Another embodiment of ICFP is depicted in FIG. 10. Although many different constructions and materials are envisioned, the exemplary embodiment shown in FIG. 10 comprises a standard, schedule 80, carbon steel pipe 57 with 24 inches outside diameter and 5 feet in length; a standard, schedule 80, hollow flanges 60/61, welded to pipe 57 at each extremity via welding procedures assuring operations at the pressure of 300 psi (schedule 80 pipe is specified to operate at this pressure) and two standard, schedule 80, plain flanges 58/59 fastened to hollow flanges 60/61, with bolts 62 or other, commercially available means to assure operation at the indicated pressure; graphite electrodes 50/51 housed in the interior of the pipe 57. The electrodes 50/51 are of graphite composition as commercially available, such as electrodes 50/51 typically used for arc furnaces and having the individual dimension of approximately 6 inches in outside diameter and 24 inches in length. The electrodes 50/51 are retained by conductive metal holders 52/53, locked to the electrodes 50/51 by fasteners 56. The conducting metal holders 52/53 are physically and electrically interfaced to metal shafts 54/55 that protrude outside of the plain flanges 58/59. The metal shafts 54/55 have an outside diameter of 3 inches and a length of 2 feet. The metal shafts 54/55 pass through the plain flanges 58/59 via phenolic or equivalent insulating, temperature and pressure resistant bushings 81 fastened to the flanges by, for example, bolts 82/83.

It is preferred that at least one of conducting metal shafts 55/59 is movable along an axial symmetry. In this example, a first metal shaft 55 is movable along an axial symmetry by a motor/actuator 151.

The metal shafts 54/55 are connected to a 100 Kw electric power source such as an AC-DC converter or a two phases AC power source with variable voltage up to 1,000 V and variable frequency up to 10,000 Hz by cables 84/85. The axial displacement of the electrode 51 is operated by the motor/actuator 151 for the initiation, maintenance and optimization of the electric arc in gap 99 between the graphite electrodes 50/51. The axial motion is allowed by a flexible cable 85 and a flexible hose 152.

The vessel 158 is filled with the hadronic fuel. Measurements of the hadronic fuel are monitored by a probe 260 or other industrially available means for monitoring the hadronic fuel. The vessel 158 is designed to withstand a pressure of at least 300 psi.

The pipe 57 is surrounded by a liquid 159 contained within an outer wall 153. The liquid 159 is circulated by a pump/heat exchanger 156. The liquid 159 absorbs heat produced by ICNP within the vessel 158 and transfers the heat to the heat exchanger 156 which is, for example, connected to a turbine that operates an electric generator (not shown) or other industrially available means for the production of electric current.

In some embodiments, a port 180 and related pipe pass through the flange 59 and are connected through a check valve 181 to a pump 182 that, in turn, is connected to a pipe 183 to a tank 184 containing for evacuating and/or filling the vessel 158.

In this example, channels 65/66 of about one inch in diameter are machined through the axis of electrodes 50/51 and the channels 65/66 continue along the axial symmetry of metal holders 52/53 and metal shafts 55/66. The channels 65/66 are fluidly connected by 1 inch diameter standard steel pipes 69/70 and fittings 67/68 to a pump 90. A drain 71 is connected via 2 inches diameter standard steel pipe 91 to the pump 90. For conservation of heat, it is preferred that thermal insulation covers the entire system.

A port 63 is provided for extraction of the resulting gas.

The operation of this exemplary system follows. Firstly, the apparatus is evacuated, and then filled with a hadronic fuel. The controlled fusion is between the carbon provided by the electrodes 50/51 and a suitably selected gas (hadronic fuel), such as deuterium, oxygen or another gas. The arc is initiated and the power, pressure, flow, trigger and other features of the reactor are adjusted to achieve operation at constant temperature. The fuel (gas) is circulated through the gap 99 and, hence, through the arc by the pump 90, thereby moving newly fused molecules out of the arc and providing fresh gas (hadronic fuel) into the arc for fusion with carbon from the electrodes 50/51.

The ICFP produces heat and the heat is collected by the fluid 159 surrounding the chamber 158. The heat from the fluid 159 is then routed through heat exchangers 156 for production of, for example, electrical energy as known in the industry.

In this example various valves 69/201/190/192/194, pipes 191, fittings 91 and tanks 193/195 are optionally provided for evacuation, filling and emptying of the vessel 158. also, in this example, instead of carbon electrodes 50/51, non-consumable, temperature resistant, conducting electrodes 50/51, such as thoriated tungsten, are anticipated. With such electrodes 50/51, the hadronic fuel must comprise a suitable mixture of two suitably selected gases, such as a 50-50 mixture of oxygen and deuterium.

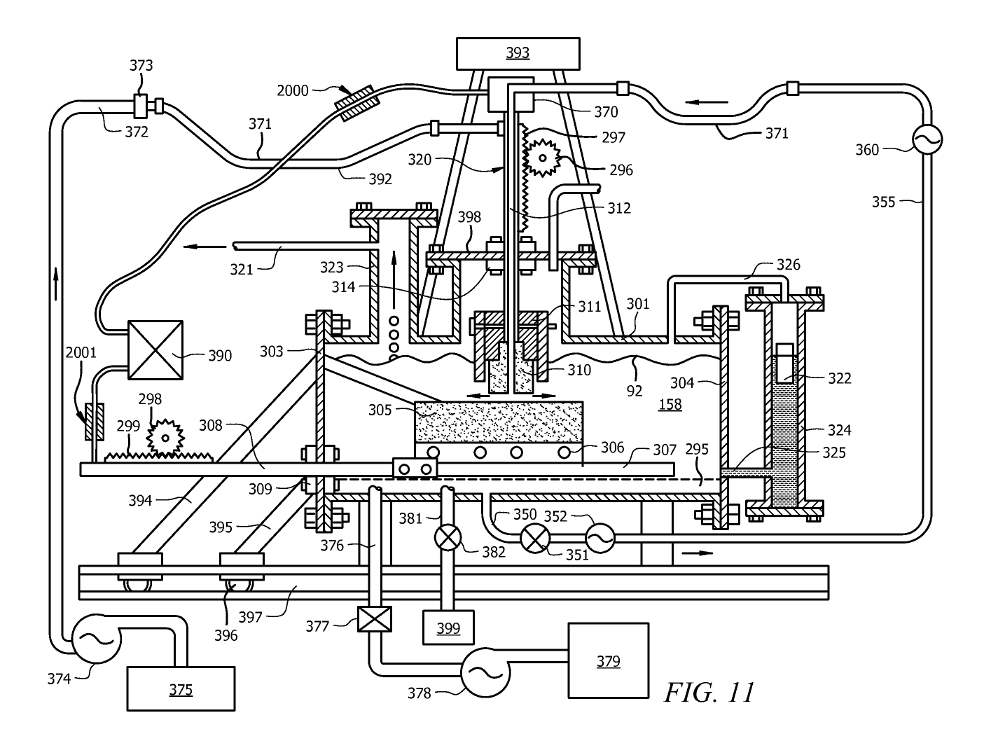

A second exemplary system is shown in FIG. 11. This exemplary system includes a vessel 301 consisting of, for example, a horizontal Schedule 80 carbon steel pipe 301 that is 2 ft in OD and 7 ft in length, completed by welded-on terminal hollow flanges also made of Schedule 80 carbon steel, and schedule 80 plain carbon steel flanges 303/304.

In this example, one electrode 305 is horizontal, made of carbon of 5″ width, 10″ height and 3 ft length. The electrode 305 is held by a pair of conducting metal bars 306, one on each side of the electrode 305. The metal bars 306 are housed on an electrically insulated sled 307 that moves horizontally from the extreme right to the extreme left within the vessel 158. The metal bars 306 are electrically connected and fastened to conducting metal shaft 308, typically of 3 inches in diameter. The metal shaft 308 protrudes outside plain flange 303 through seals 309, sealing the vessel 158 and electrically insulating the shaft 308. The shaft is preferably at least 8 ft long so as to allow the entire travel of sled 307 from the extreme right to the extreme left within the vessel 158. In this example, the horizontal motion is performed by a commercially available low speed electric motor (not shown) coupled to the shaft 308 by a rack 299 and gear 298 to move the electrode 305 about ½ inch per minute during ICFP.

A second vertically placed carbon electrode 310 is held by conducting fastener 311 that is electrically connected and affixed to a 3″ diameter metal shaft 320 that protrudes outside collar 398 through seals contained in an electrically insulating bushing 314. The shaft 320 is at least 3 ft long so as so allow the vertical motion upward and downward of the electrode 310 closer and away from the electrode 305. The electrode 310 has the same 5 inches width of electrode 305, but a length of 10 inches and 1 ft height. The assembly consisting of electrode 310, holder 311 and shaft 320 having an axial bore 312 of 1 inch ID for its entire axial length. The electrode 310 is moved towards/away the electrode 305 by a motor (not shown) interfaced to a rack 297 by a gear 296. Rotation of the gear 296 translates into movement of the shaft 320 and, correspondingly movement of the electrode 310 towards/away from the electrode 305.

The vessel 158 is further completed by tower 323 and flange 398. In some embodiments, the vessel 158 is filled with a gas through a pipe 376, one-directional check valve 377, pump 378 and source tank 379.

The hadronic gas is circulated through the arc between the electrodes 305 and 310 by a pump 352. The gas from the vessel 158 exits through an exit pipe 350 and valve 351 and is pumped by the pump 352 through a pipe 355, valve 360 and flexible joint 371, delivering the gas flow through the axial bore 312 in the interior of shaft 320. The gas is then forced into the gap between the electrode 310 and the electrode 305 in the vicinity of the arc.

In some embodiments, the vessel 158 is further equipped with an external source tank 375, valve 374, steel pipe 372 and hose 371, the latter being flexible so as to deliver the gas to the joint 370 while shaft 312 moves up or down.

In some embodiments, the vessel 158 is further equipped with means to remove the gas from its interior consisting of a pipe 381 and valve 382 and a tank 399.

The apparatus is connected to a DC power source 390 such as two 100 Kw power units 390, the first of which consisting of an AC-DC converter and the second consisting of an AC power source with voltage variable up to 600 V and frequency variable up to 10,000 Hz. One polarity of the power source 390 is connected to metal shaft 308 by a cable 2001. A second polarity of the power source 390 is connected to the metal shaft 320 by a second cable 2000.

The apparatus is controlled by an electronic control 393 that is electrically connected to all valves, all pumps and all sensors for control of operation. The electronic control 393 initiates an electric arc by a short between electrodes 305 and 310 then maintains stability of the arc by micro-metric motions upward or downward of shaft 320, and optimizes the arc by the increase of the gap up to such value permitting a stable arc with a pre-determined variation of the voltage.

For completeness, the plain flanges 303 is welded to supports 394/395 that connect to wheels 396 that operate upon railing 397, so as to allow the removal of the entire internal assembly of the electrode 305 for replacement. In some embodiments, the apparatus is additionally equipped with a hydraulic lift as known in the art, for the lifting of flange 398 to expose of electrode 310 for replacement of the electrode 310.

The apparatus is equipped with a heat transfer and generator system as that of the embodiment of FIG. 10, not shown in FIG. 11 to avoid unnecessary repetition. For example, a metal chamber surrounding the entire outside of vessel 158 through which a coolant is circulated and connected to system for the conversion of heat into, for example, electricity.

The operation of this second preferred embodiment are essentially the same as that of the embodiment of FIG. 10, including firstly the proper selection of the gaseous hadronic fuel whenever carbon electrodes are used, or the selection of the proper mixture of two gases allowing ICFP as per the description presented above.

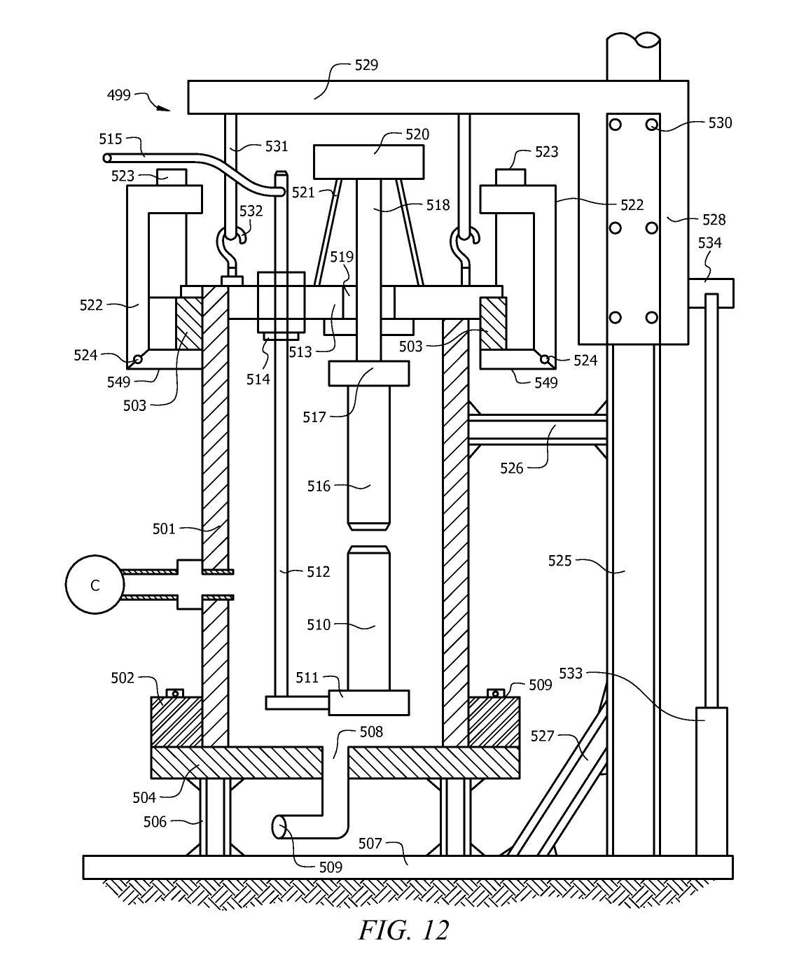

FIG. 12 depicts another embodiment which provides improved operating life prior to the replacement of the electrodes. The exemplary embodiment of FIG. 12 comprises: a metal vessel 501 of two feet wide, 7 feet high and the desired length generally being of 9 feet. Flanges 503 are welded to the vessel 501. The lower part of the vessel 501 is sealed by a pressure resistant metal plate 504 that is fastened to flanges 502 via bolts 509 or similar means. The metal plate 504 is supported by metal legs 506 for support as well as to provide at least one foot clearance between metal plate 504 and the ground 507. The upper part of the vessel 501 is sealed by a metal plate 513, held in place by hinged flanges 522/549. For quick and easy removal of the upper metal plate 513, the flanges 522/549 are hinged at pivot 524 to enable the upper hinged portion 522 of the hinged flanges 522/549 to swing outwardly and down with respect to the lower hinged portion 549 upon removal of the bolts 523.

The vessel 501 contains in a lower electrode 501 made of 5 inches diameter and 3 feet long carbon. The lower electrode 501 is held by a metal holder 511 connected to a metal rod 512 that passes through the upper metal plate 513 through an insulating bushing 514. An upper electrode 516, typically 5 inches diameter 3 feet long carbon is held by a metal holder 517 that is electrically and physically connected to a movable upper electrode rod 518 that protrudes through the upper metal plate 513, passing through an insulating bushing 519. The protruding part of the upper electrode rod 518 is connected to a device 520 that provides upward/downward movement (e.g. an actuator 520). Upward movement of the upper electrode rod 518 and, hence, the upper electrode 516 with respect to the lower electrode 510 controls the arc between the electrodes 510/516. The device 520 that provides upward/downward movement (e.g. an actuator 520) is mounted to the upper metal plate 513 by legs 518.

Electric power is delivered to electrodes 510/516 by cables 515 connected to the electrode rods 512/518.

Operations are essentially the same as those of the embodiment of FIG. 10 and FIG. 11, the main difference being that, at the exhaustion of either of the electrodes 510/516, bolts 523 are loosened or removed and the upper plate 513 freed from the hinged flanges 522/549. The upper plate 513 is forced upwardly by one or more hydraulic pistons 533 interfaced to the upper plate 513 by two or more hydraulic clamps 534 connected to a bridge 529 by a sleeve 528. The sleeve 528 freely moves vertically on a shaft 525 that is welded to the base and supported by a base member 527 and a side member 526. As the piston(s) 533 push upwardly, the sleeve 528 moves upwardly on the shaft 525 until the upper plate 513 is high enough away from the pipe 501 as to remove/replace the electrodes 510/516.

In some embodiments, to initiate fusion of the atoms of the gas molecules that are aligned within the arc, the DC voltage to the arc is pulsed, preferably at a frequency that resonates with the resonate frequency of the gas molecules within the chamber 501 such as a submultiple of the resonate frequency of the gas molecules. In alternate embodiments, to initiate fusion of the atoms of the gas molecules that are aligned within the arc, a pulsed source of pressure C is connected to the chamber 501, providing pulses of pressure within the chamber 501. Sources of pressure pulses include, but are not limited to, sudden force on a piston, a small explosion, etc. Such sources of pressure pulses C are anticipated for all embodiments.

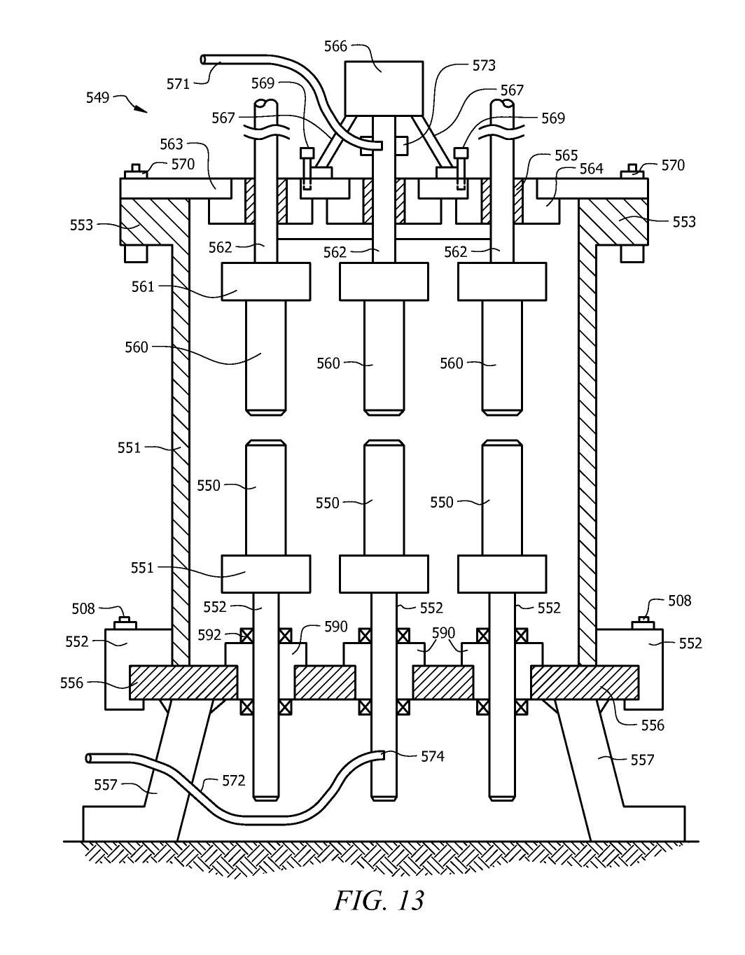

FIG. 13 depicts another embodiment 549 designed to achieve greater throughput and a longer operating life before maintenance of the electrodes. The circulation control system is not described for brevity purposes.

The system 549 has metal edges 552/553 welded to the walls 551 of the vessel 549. The lower part of vessel 549 is completed by a pressure resistant metal plate 556 that is fastened to edges 552 via bolts 508 or similar means. The metal plate 556 is supported by legs 557 to provide clearance between the plate 556 and the ground (e.g. at least one foot clearance). There are three or more lower electrodes 550 (e.g., five inches diameter and three feet long carbon electrodes), each lower electrode 550 is held by a conducting metal holder 551 and each lower electrode 550 is connected to a lower metal rod 552 (e.g. three inches diameter metal rods). The lower metal rods 552 protrude through the plate 556 and are insulated from the plate 556 by bushings 590 that have collars 592. The rods 552 are fixed in place (do not move up/down).

The vessel 549 has three or more upper electrodes 560 (e.g., five inches diameter and three feet long carbon electrodes). Each upper electrode 560 is held by a conducting metal holder 561 and each upper electrode 560 is connected to an upper metal rod 562 (e.g. three inches diameter metal rod) that protrudes through the plate 563. The upper metal rods 562 are insulated from the plate 564 by bushings 565. The bushings 565 seal the vessel 549 while enabling upward and downward movement of upper metal rods 562.

A protruding end of one of the upper rods 562 is removably fastened to an actuator 566 (or other movement device) for the automatic control of the arc between upper electrode 550 and the lower electrode 560. The actuator 566 is supported by rods 567 that are affixed to the top plate 563 by removable fasteners 569. The vessel 549 is closed by the top plate 563 fastened to the top edge 553 by, for example, bolts 570.

Electric power is delivered to electrodes 550/560 by power cables 571/572 and electric connectors 573/574, respectively. The electric connectors 573/574 are such that the power cables 571/572 are easily and quickly moved to any of the other rods 552/562 and, therefore, electrodes 550/560.

In operation, for tuning of the arc and compensation as the electrodes 550/560 erode, the actuator 566 moves the upper electrode 560 closer or farther from the lower electrode 550 to which the actuator 566 is attached. When a first set of electrodes 550/560 are exhausted, the actuator 556 is unbolted from the top plate 563 and detached from the upper shaft 562 corresponding to the first set of electrodes 550/560. The actuator 556 is then transferred to another upper rod 552 of a good set of electrodes 550/560 and reattached/bolted to the top plate 563. The electrical cables 571/572 are then disconnected from the upper rod 562 and lower rod 552 corresponding to the first set of electrodes 550/560 and connected to the upper rod 562 and lower rod 552 corresponding to the good set of electrodes 550/560. In this way, minimal interruption of operation is achieved by quickly transferring operation from one set of electrodes 550/560 to a next set of electrodes 550/560 without disassembling the entire recycler 549. Furthermore, the purity of the hadronic gas is not compromised by opening of the chamber 549 for replacement of the electrodes 550/560.

Operations being essentially the same as those of the embodiment of described above, the main difference being that with the exhaustion of one set of electrodes 550/560, the power and actuator 566 (for the control of the arc) is moved to another set of electrodes 550/560 until all sets of electrodes 550/560 are exhausted, thereby increasing the operating time before maintenance is needed.

Although shown with three electrode pairs 550/560, any number of pairs is anticipated including two pairs. Also, although shown with one actuator 566, in some embodiments, multiple actuators 566 are employed such as one actuator 566 per pair of electrodes 550/560. Although shown as a removable electric connection between the power cables 571/572 and the rods 562/552, it is anticipated that in some embodiments, each rod has an attached cable and the electric power is switched to the pair of electrodes 550/560 by one or more electric switches (not shown).

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A method for intermediate fusion of a first atom of a first element with a second atom of a second element without the emission of harmful radiation and without the release of radioactive waste, the first and second atoms being light, natural and stable; a fused atom resulting from the intermediate fusion is also being light, natural and stable; the method comprising:
exposing the first and second atoms to a magnetic field within a pressurized chamber causing the polarization of electron orbits into a toroid, the electrons of the first and second atoms having a toroidal shape results in exposure of the nuclei of the first atom to the nuclei of the second atom; and
providing a trigger, the trigger forcing the nuclei of the first atom to fuse with the nuclei of the second atom, thereby fusing the first atom and the second atom into the fused atom.

2. The method for intermediate fusion of claim 1, wherein the magnetic field is provided by an electric arc, the electric arc produced between a first electrode and a second electrode within the pressure chamber.

3. The method for intermediate fusion of claim 2, wherein the first atom is deuterium provided by a gas within the pressurized chamber, at least one of the first and second electrodes comprises carbon, the second atom is carbon provided by one or both electrodes, and the fused atom is nitrogen.

4. The method for intermediate fusion of claim 2, wherein the first atom is a carbon atom and the second atom is an oxygen atom, the carbon atom and the hydrogen atom are provided by carbon dioxide gas within the pressurized chamber, the carbon dioxide molecule is molecularly separated into the carbon atom and the oxygen atom by the electric arc, and the fused atom is silicon dioxide (silica).

5. The method for intermediate fusion of claim 2, wherein the first element is oxygen provided by air within the pressure chamber, at least one of the positive and the negative electrodes includes carbon, the second element is carbon from at least one of the electrodes and the fused element is carbon dioxide.

6. The method for intermediate fusion of claim 1, wherein the trigger is a disruption in an electric power provided to the electrodes, thereby disrupting the electric arc.

7. The method for intermediate fusion of claim 1, wherein the trigger is a disruption in an electric power provided to the electrodes caused by a pulse of the electric power, thereby periodically disrupting the electric arc.

8. The method for intermediate fusion of claim 8, wherein a period of the pulse of the electric power is a harmonic of a natural resonate frequency of at least one of the first and second atoms.

9. The method for intermediate fusion of claim 1, wherein the trigger is an abrupt increase of a pressure within the chamber.

10. A method for intermediate fusion of a first element with a second element into a fused element without the emission of harmful radiation and without the release of radioactive waste; atoms of the first element and atoms of the second elements being light, natural and stable; atoms of the fused element also being light, natural and stable; the method comprising:
providing a pressure chamber having at least a positive electrode and a negative electrode within the pressure chamber, the positive and negative electrodes electrically connected to a switched source of power;
evacuating the pressure chamber;
filling the pressure chamber with a gas, thereby increasing a pressure within the pressure chamber to an operational pressure;
enabling the switched source of power, thereby initiating an electric arc between the positive electrode and the negative electrode;
providing at least one trigger, the trigger fusing atoms of the first element with atoms of the second element into the atoms of the fused element.

11. The method for intermediate fusion of claim 10, wherein both the first element and the second element are contained within the gas.

12. The method for intermediate fusion of claim 10, wherein the first element is contained within the gas and the second element is provided from at least one of the first electrode and the second electrode.

13. The method for intermediate fusion of claim 10, wherein the pressure is between 300 pounds per square inch and 3,000 pounds per square inch.

14. The method for intermediate fusion of claim 12, wherein the first element is deuterium provided by the gas, the second element is carbon provided by at least one of the first and second electrodes and the fused element is nitrogen.

15. The method for intermediate fusion of claim 11, wherein the gas is carbon dioxide, the first element is carbon and the second element is oxygen, the fused element is silicon dioxide (silica), and the carbon and oxygen are provided by molecular separation of the carbon dioxide by the electric arc.

16. The method for intermediate fusion of claim 10, further comprising the step of capturing heat from the pressure chamber and using the heat to generate electric power.

17. An apparatus for intermediate fusion of a first element with a second element into a fused element without the emission of harmful radiation and without the release of radioactive waste; atoms of the first element and atoms of the second element being light, natural and stable; atoms of the fused element also being light, natural and stable; the apparatus comprising:
a source of electric power;
a pressure chamber;
at least one positive electrode and at least one negative electrode within the pressure chamber, the positive and negative electrodes electrically connected to the source of electric power;
means for evacuating the pressure chamber;
means for filling the pressure chamber with a gas, the means for filling increasing a pressure within the pressure chamber to an operational pressure as the pressure chamber is filled with the gas;
means for initiating an electric arc between the at least one positive electrode and the at least one negative electrode; and
means for triggering the fusion of atoms of the first element with atoms of the second element into atoms into atoms of the fused element.

18. The apparatus for intermediate fusion of claim 17, further comprising means for capturing heat from the fusion and using the heat to generate electric power.

19. The apparatus for intermediate fusion of claim 17, further comprising means for circulating the gas through at least one of the at least one positive electrode and the at least one negative electrode, thereby forcing the atoms of the resulting element out of the electric arc.

20. The apparatus for intermediate fusion of claim 17, wherein the means for triggering the fusion is a periodic, abrupt change in the electric power.
